(19) United States
(12) Patent Application Publication
(10) Pub. No.: US 2012/0166808 A1
(43) Pub. Date: Jun. 28, 2012

(54) LATTICE-BASED RING SIGNATURE METHOD

(75) Inventors: Do Won HONG, Daejeon (KR); Ik Rae JEONG, Seoul (KR); Geontae NOH, Seoul (KR)

(73) Assignee: Electronics and Telecommunications Research Institute, Daejeon (KR)

(21) Appl. No.: 13/335,821

(22) Filed: Dec. 22, 2011

(30) Foreign Application Priority Data
Dec. 23, 2010 (KR) 10-2010-0133610

(51) Int. Cl. H04L 9/32

(52) U.S. Cl. 713/180

(57) ABSTRACT

A lattice-based ring signature method includes generating a dimension, a bound, a length of a hashed message, a Gaussian parameter and an open parameter, which are parameters necessary for a ring signature. Further, the lattice-based ring signature method includes generating a signature key and a verifying key for a user who construct a ring by using the parameter necessary for the ring signature. Furthermore, the lattice-based ring signature method generating a signature for a message and the ring by using the signature key and the verifying key.

### CROSS-REFERENCE TO RELATED APPLICATION(S)

The present invention claims priority of Korean Patent Application No. 10-2010-0133610, filed on Dec. 23, 2010, which is incorporated herein by reference.

### FIELD OF THE INVENTION

The present invention relates to a ring signature method; and, more particularly, to a lattice-based ring signature method satisfying stronger unforgeable safety than that of conventional ring signature schemes.

### BACKGROUND OF THE INVENTION

Ring signature is a variation of a group signature scheme, which was introduced by David Chaum et al. in 1991. According to the group signature, a member of a group signs documents on behalf of the entire group, and the other members on the group only know that an anonymous member of the group signed the document (anonymity). If there occurs a problem, members of the group can trace who is a group manager (traceability). Therefore, in the group signature, there exists a group manager who is able to trace s signature. Moreover, in a dynamic group, a process for joining in and withdrawal from the group is required.

On the other hand, according to the ring signature, a signer forms a ring of any set of possible ring by freely selecting members of the ring, and signs documents on behalf of the ring. In ring signature, similar to the group signature, the members of the ring may know someone in the ring signed the document (anonymity). However, unlike the group signature, it is difficult for anyone in the ring to trace the signer. In other words, anyone in the ring cannot know who sign the document. Therefore, ring signature does not require a group manager, and does not need to process for joining in and withdrawal from the ring. Accordingly, the ring signature may be utilized in a whistle-blower system.

Ring signature was first introduced by Ronald L. Rivest in 2001, and has been designed based on various schemes such as factorization-based ring signature, bilinear map-based ring signature, and lattice-based ring signature, etc. Such ring signatures have been designed mainly based on a safety model, which was established by Adam Bender at al. in 2006. Adam Bender at al. classified an anonymity model into four models, which are basic anonymity, anonymity w.r.t. adversarially-chosen keys, anonymity against attribution attacks, and anonymity against full key exposure, and classified an unforgeability model into three models, which are unforgeability against fixed-ring attacks, unforgeability against chosen-subring attacks, and unforgeability w.r.t. insider corruption.

However, the above three unforgeability models satisfy only weak unforgeability, and a safety model for strong unforgeability has not been established. Therefore, all the ring signature schemes introduced until now have been designed to satisfy only weak unforgeability, and there has not been a ring signature scheme satisfying strong unforgeability.

General signature schemes introduced up to now have been designed to gradually satisfy strong unforgeability. Accordingly, it is required in the ring signature schemed to establishing and designing a safety model satisfying strong unforgeability.

### SUMMARY OF THE INVENTION

In view of the above, the present invention provides a lattice-based ring signature method satisfying unforgeability stronger than those of conventional signature method.

However, the object of the present invention is not limited above mentioned object, rather, other objects of the present invention may be understood in view of following description by those who are skilled in the art.

In accordance with an embodiment of the present invention, there is provided a lattice-based ring signature method including generating a dimension, a bound, a length of a hashed message, a Gaussian parameter and an open parameter, which are parameters necessary for a ring signature; generating a signature key and a verifying key for a user who construct a ring by using the parameter necessary for the ring signature; and generating a signature for a message and the ring by using the signature key and the verifying key.

In accordance with the present invention, it is possible to provide the lattice-based ring signature method satisfying stronger unforgeable safety. Further, when implementing a whistle-blower system using the lattice-based ring signature method satisfying the stronger unforgeable safety, it is possible to obtain safer configuration than that of conventional one.

### BRIEF DESCRIPTION OF THE DRAWINGS

The objects and features of the present invention will become apparent from the following description of embodiments, given in conjunction with the accompanying drawings, in which:

FIG. 1 is a diagram showing a basic structure in which a ring signature method in accordance with an embodiment of the present invention is applied; and

FIG. 2 is a flow chart describing processes for lattice-based ring signature and verification thereof.

### DETAILED DESCRIPTION OF THE EMBODIMENTS

Embodiments of the present invention will be described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described with reference to the accompanying drawings which form a part hereof.

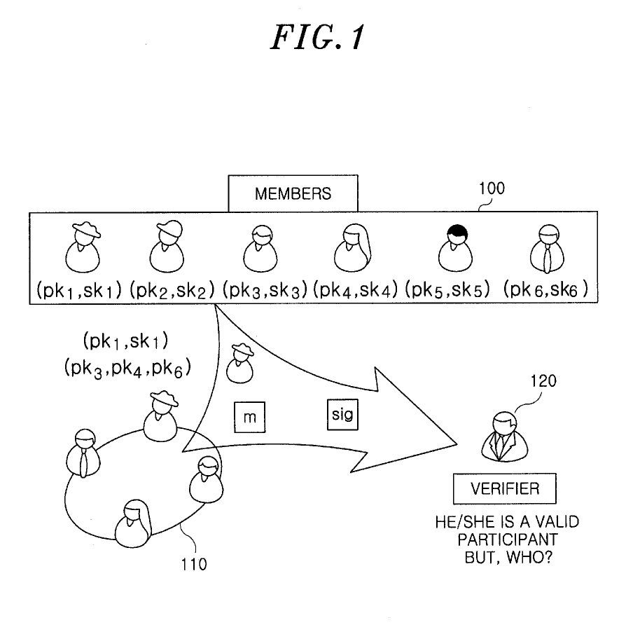

FIG. 1 is a diagram showing a basic structure in which a ring signature method in accordance with an embodiment of the present invention can be applied.

As shown in FIG. 1, in a ring signature in accordance with an embodiment of the present invention, members, who constitutes a ring 110, may be selected among a plurality of members 100. A legitimate member can sign a message on behalf of the ring 110. A verifier 120 verifying a signature in the ring signature scheme can only know that a member of the ring 110 has signed, but cannot know who has signed in the ring 110.

Variables used in an embodiment of the present invention are as follows.

In an embodiment of the present invention, n is used as a security parameter. It is assumed that the same security parameter n is embedded in all algorithms (including attacker). A set of integers modularized with integer q(q≧1) is represented by Z_{q}. For a certain word array x, |x| represents a length of x. For a certain set K, |K| represents the number of elements of K. For a function of n, when it is disappeared faster than any polynomials of n, it is presented as negl(n). A statistical distance between two distributions (or two random variables having each distribution) X and Y can be defined as max_{A⊂D}|X(A)−Y(A)|, in view of a function on a countable domain of definition D.

A column vector is indicated with lower case (for example x), and a matrix is indicated with upper case (for example X. A matrix X is a set of column vectors {xᵢ} having sequence, and X∥X′ represents a concatenation having sequence of X and X′. For a set S={s₁, . . . sₖ}⊂R^{m} of linear independent vectors having a certain sequence, Gram-Schmidt orthogonalization is represented by \tilde{S}={\tilde{s}\tilde{s₁}, . . . \tilde{s}\tilde{sₖ}}.

In accordance with an embodiment of the present invention, ring signature is based on lattice. In an embodiment of the present invention, a ring signature scheme for a message space M and ring space R is constituted by a tuple of three algorithms, i.e., Gen, Sign, and Vrfy. Here, a ring space R={vk₁, . . . , vkₖ} means a set of verifying keys having sequence. In ring signature, Gen outputs a signature key sk and a verifying key vk. Sign (sk, r, m) outputs s signature σε{0,1}*, when the signature key sk, a ring rεR, and a message mεM are given. Vrfy(r, m, σ) outputs 1 or 0, when the ring r, the message m, and the signature σ. Herein, 1 means a legitimate signature, and 0 means an illegitimate signature.

When it is said that a ring signature satisfies accuracy, it means that, for a certain message mεM, a ring rεR, a signature key and a verifying key (sk, vk)←Gen and a signature σ←Sign(sk, r, m), the Vrfy(r, m, σ) algorithm performs accurate verification with overwhelming probability, in other words, outputs 1. Herein, the probability is calculated for every random number used inside of each algorithm constituting a ring signature.

In accordance with an embodiment of the present invention, a ring signature is performed based on lattice. Hereinafter, lattice will be explained.

In an embodiment of the present invention, a full-rank integer lattice of m-dimension, which is a discrete additive subgroup of Z^{m} having finite indexes. In other words, a quotient group Z^{m}/Λ is finite. One lattice Λ⊂Z^{m} can be defined to be the same as a set of every integer linear combination of m-linear independent basis vectors B={b₁, . . . bₘ}⊂Z^{m} as following equation 1.

Λ=L(B)={B_{c}=Σ_{iε{i, . . . , m}}cᵢbᵢ:cεZ^{m}} [Equation 1]

Herein, in case of m≧2, there are many basis generating the same lattice.

All the lattices Λ [symbol] Z^{m} have a sole canonical basis H=HNF(Λ)εZ^{m×m}, which is called to be HNF (hermite normal form). Since HNF is efficiently calculated when a arbitrary basis B is given, a HNF basis is used. A HNF of a lattice which is generated by basis B is indicated as HNF(B).

In an embodiment of the present invention, a certain type of an integer lattice as follows is used. Here, it is assumed that n (n≧1), and q(q≧1) are integers, a dimension n is a security parameter used in an embodiment of the present invention, and all the other parameters are embedded as functions of n. Herein, a m-dimension hard lattice is generated by a parity check matrix AεZ_{q}^{n×m}, and defined as following equation 2.

Λ⊥(A)={xεZ^{m}:Ax=Σ_{jε{i, . . . , m}}xⱼ·aⱼ=0εZ_{q}ⁿ} [symbol] Z^{m} [Equation 2]

For a certain y, a coset generated by the parity check matrix AεZ_{q}^{n×m} is defined as following equation 3.

Λ_{y}⊥(A)={xεZ^{m}:Ax=yεZ_{q}ⁿ}=Λ⊥(A)+ x̅ [Equation 3]

Herein, x̅εZ^{m} is an arbitrary element of Λ_{y}⊥.

For an arbitrary fixed constant C>1 and a certain m≧Cn log q, uniformly random column vector of AεZ_{q}^{n×m} can generate everything on Z_{q}ⁿ (except for probability 2^{-Ω(n)}=negl(n)). Therefore, in an embodiment of the present invention, uniformly random A is used.

Next, SIS (short integer solution) problem of a hard lattice will be explained. This problem belongs to an average-case hardness problems, and Miklós Ajtai found a method for connecting this problem as a worst-case hardness problem.

SIS problem is to find a non-zero integer vector vεZ^{m} satisfying ∥v∥₂≦β and Av=0εZ_{q}ⁿ (i.e., vεΛ⊥(A)), with receiving a matrix AεZ_{q}^{n×m} as an input, which is uniformly random to m=poly(n).

A Gaussian distribution in lattice A Gaussian function is defined as ρₛ: R^{m}→(0,1], ρₛ(x)=exp (−π∥x∥²/s²) for certain s>0, and a dimension m≧1. For a certain coset Λ_{y}⊥(A), a discrete Gaussian distribution D_{Λ}_{_{y}}_{⊥(A),S} on the coset, center of which is 0, has a probability proportional to ρₛ(x) in each xεΛ_{y}⊥(A).

Next, characteristics of Gaussian distribution in lattice in an embodiment of the present invention is as following equation 4.

$${Pr}_{x ← {D}_{{A}_{{Λ}_{y} , S}}} [ ‖ x ‖ 〉 s \cdot \sqrt{m} ] \leq negl ( n ) \\ {Pr}_{x ← {D}_{{Λ}_{y}} ⊥ ( A ) , S} [ x = 0 ] \leq negl ( n ) \qquad [ Equation 4 ]$$

Herein, S means a basis of Λ⊥(A)) to a certain AεZ_{q}^{n×m}, and s≧∥\tilde{S}∥·ω(\sqrt{log n}).

A PPT algorithm SampleD(S,y,s) capable of sampling with trapdoor S from D_{Λ}_{_{y}}_{⊥(A),S} (having negl(n) statistic distance) exists, but there is no PPT algorithm capable of without trapdoor S. There exists a SampleDom algorithm capable of sampling a domain of definition of a SampleD(S,y,s) algorithm from Gaussian distribution. In other words, range of x sampled by the SampleDom algorithm is ∥s∥≦s\sqrt{m}. Herein, s≧σ₁(S)·ω(\sqrt{log n}), and σ₁(S) is the largest singular value, which is not absolutely shorter than ∥\tilde{S}∥, but not larger than that in most important cases.

In an embodiment of the present invention, a GenBasis algorithm generating a short basis of lattice. As an input of the GenBasis algorithm, (1ⁿ,1^{m},q) is received, which is represented as GenBasis(1ⁿ,1^{m},q). Herein, polynomial bound (poly(n)-bounded) m≧Cn log q. Then, the GenBasis algorithm outputs AεZ_{q}^{n×m} and SεZ^{n×m} satisfying follows. Herein, distribution of A has a negl(n) statistic distance, S is a basis of Λ⊥(A)), and ∥\tilde{S}∥≦\tilde{L}=0(\sqrt{log n}).

S generated by using GenBasis algorithm is used as a trapdoor, that is a signature key, in an embodiment of the present invention.

ExtBasis algorithm for delegating a short basis of lattice in accordance with an embodiment of the present invention will be explained. ExtBasis algorithm receives (S,A′=A∥Ā) as an input. This may be represented as ExtBasis(S,A′=A∥Ā). Herein, S is a basis of Λ⊥(A), AεZ_{q}^{n×m}, and ĀεZ_{q}^{n× m̅}. The ExtBasis algorithm outputs S′εZ^{n′×m′} satisfying follows. Herein, m′=m+ m̅, S′ is basis of Λ⊥(A), and ∥\tilde{S}′∥=∥\tilde{S}∥. Also, PS′ is a basis of Λ⊥(A′P). Herein, P is a permutation matrix.

In accordance with an embodiment of the present invention, a ring signature satisfying strong unforgeability can be generated by using the three algorithms (i.e., SampleD, GenBasis, and ExtBasis) explained in the above.

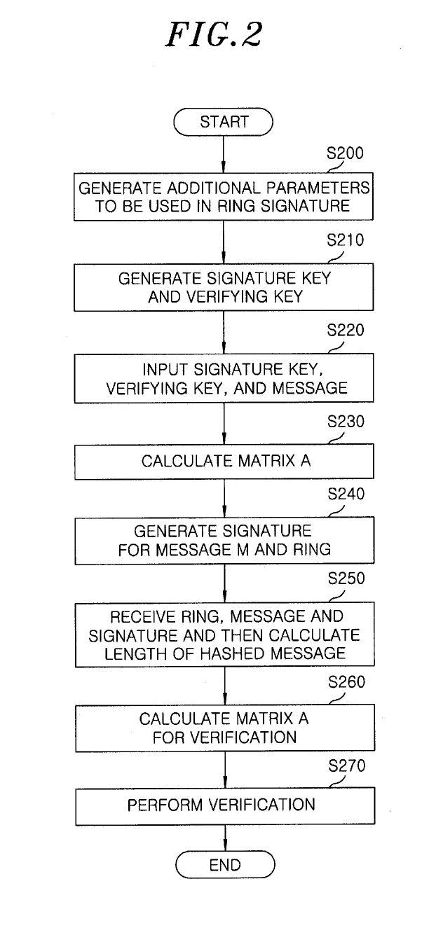

FIG. 2 is a flowchart describing processes for lattice-based ring signature and verification thereof.

First, before a ring signature, a reliable key setup authority generates additional parameters to be used in an embodiment of the present invention by performing Global Setup algorithm in step S200.

The parameters that the key setup authority generates by using the Global Setup algorithm are as follows.

The parameters are a dimension m=0(n log q), a bound \tilde{L}=0(\sqrt{n log q}), and a length of hashed message |u|, which means that a dimension of the ring signature is m′=m·max(|r|,|u|). Herein, |r| means the number of members belonging to a ring r.

In accordance with an embodiment of the present invention, the length of hashed message can be generated by using a collision-resistant hash function as shown in equation 5.

h(•,•):{0,1}*×{0,1}*→{0,1}^{|u|} [Equation 5]

Also, a Gaussian parameter s=\tilde{L}·ω(\sqrt{n log m′}), and a open parameter params={B₁⁽⁰⁾, B₁⁽¹⁾, . . . , B_{|u|}⁽⁰⁾, B_{|u|}⁽⁰⁾, y} can be generated. Herein, Bⱼ^{(b)}εZ_{q}^{n×m} is a uniformly random and independent 2|u| numbers of n×m matrixes, and yεZ_{q}ⁿ is a uniformly random n×1 column vector.

Each user constructs a ring signature scheme RS={Gen,Sign,Vrfy} as follows by using the open parameters generated through the Global Setup algorithm.

Gen: i-th user obtains Aᵢ⁽⁰⁾εZ_{q}^{n×m}, Aᵢ⁽¹⁾εZ_{q}^{n×m} and Sᵢ⁽⁰⁾εZ_{q}^{n×m}, Sᵢ⁽¹⁾εZ^{n×m} by performing twice GenBasis{1^{m},1ⁿ,q} algorithm. Herein, Sᵢ⁽⁰⁾ is a short basis ∥ [symbol] ∥≦\tilde{L} of Λ⊥(Aᵢ⁽⁰⁾), and Sᵢ⁽¹⁾ is a short basis ∥ [symbol] ∥≦\tilde{L} of Λ⊥(Aᵢ⁽¹⁾). Consequently, a signature key of i-th user is generated to be skᵢ={Sᵢ⁽⁰⁾,Sᵢ⁽¹⁾} and a verifying key is generated to be vkᵢ={Aᵢ⁽⁰⁾,Aᵢ⁽¹⁾} in step S210.

Then, for Sign(skᵢ,r,m), a signature key≧skᵢ+{Sᵢ⁽⁰⁾,Sᵢ⁽¹⁾}, a ring r={vk₁, . . . , vk_{|r|}}, and a message mε{0,1}* are received as an input of Sign algorithm in step S220. Here, iε{1, . . . , |r|}.

Random value rε{0,1}* is selected, and μ=h(m,γ)=u₁∥ . . . ∥u_{|u|} is calculated. Then, difference between |u| and |r|, a matrix A is calculated as following equation 6, considering three cases in step S230.

In case of |u|=|r|, A=A₁^{(u}^{₁}⁾∥ . . . ∥A_{|u|}^{(u}^{_{|u|}}⁾εZ_{q}^{n×m′} [Equation 6]

In case of |u|>|r|,

A=A₁^{(u}^{₁}⁾∥ . . . ∥A_{|u|}^{(u}^{_{|r|}}⁾∥B₁^{(u}^{_{|r+1|}}⁾∥ . . . B_{|u|-|r|}^{(u}^{_{|u|}}⁾εZ_{q}^{n×m′}

In case of |u|<|r|, A=A₁^{(u}^{₁}⁾∥ . . . ∥A_{|r|}^{(u}^{_{|r|mod|u+1|}}⁾εZ_{q}^{n×m′}

Here, j={1, . . . , |u|} is an arbitrary value. A is constructed by sequentially repeating verifying key values of ring r until the last value u_{|r|} of u.

A constructed as shown in the above is applied to equation 7. In other words, v is calculated by applying the matrix A to the SampleD algorithm and the ExtBasis algorithm.

v←SampleD(ExtBasis(Sᵢ^{(u}^{ᵢ}⁾,A),y,s) [Equation 7]

From the result of equation 7, a signature σ=(v,r) for the message m and the ring r can be generated in step S240.

Then, a verifying step may be performed. In other words, in Vrfy(r,m,σ), the ring r, the message rn, and the signature σ=(v,r) are received as an input of Vrfy algorithm, and then the length of hashed message u=h(m,r) is calculated in step S250.

Then, the matrix A for verification is calculated in the same way as calculated in the Sign algorithm. In other words, in accordance with a length difference between |u| and |r|, the matrix A for verification is calculated as the above equation 6, considering three cases, and v is calculated by applying the matrix A to the SampleD algorithm and the ExtBasis algorithm, so that verification is performed in step S270.

That is, if ∥v∥≦s\sqrt{m} and Av=y, then 1 is output.

Otherwise, 0 is output.

Accuracy of a ring signature method RS={Gen,Sign,Vrfy} in accordance with an embodiment of the present invention is as follows.

Only person who knows signature key among the verifying keys of the ring r can calculated a short basis of matrix A through the ExtBasis algorithm, and only person who knows the short basis can sample v satisfying ∥v∥≦s\sqrt{m} through the SampleD algorithm. Such calculated v accords Gaussian distribution D_{Λ}_{_{y}}_{⊥(A),S}, that is, y≡Av mod q.

While the invention has been shown and described with respect to the embodiments, it will be understood by those skilled in the art that various changes and modification may be made without departing from the scope of the invention as defined in the following claims.

What is claimed is:

1. A lattice-based ring signature method comprising:
generating a dimension, a bound, a length of a hashed message, a Gaussian parameter and an open parameter, which are parameters necessary for a ring signature;
generating a signature key and a verifying key for a user who construct a ring by using the parameter necessary for the ring signature; and
generating a signature for a message and the ring by using the signature key and the verifying key.

2. The method of claim 1, wherein the step for generating the open parameter includes:
generating the dimension of the ring signature by using the dimension, the bound, and the length of the hashed massage; and
generating the Gaussian distribution by using the dimension of the ring signature, and generating the open parameter by using a uniformly random and mutually independent matrix of the length of the hashed message.

3. The method of claim 2, wherein the dimension of the ring signature is generated by using a collision-resistant hash function.

4. The method of claim 1, wherein the parameters necessary for the ring signature are generating by using a Global Setup algorithm.

5. The method of claim 1, wherein said generating the verifying key and the signature key includes generating the verifying key and the signature key of a member i who is constituting the ring by performing a GenBasis algorithm twice.

6. The method of claim 5, wherein said generating the signature includes:
calculating a matrix A by using a Sign algorithm having the signature key, a set of verifying keys of members constituting the ring, and the message as inputs; and
generating the signature for the message and the ring by using the matrix A.

7. The method of claim 6, wherein said calculating the matrix A calculates the matrix A based on a difference between a number of members constituting the ring and the length of the hashed message.

8. The method of claim 7, wherein,
when the length of the hashed message is larger than the number of members constituting the ring,
A=A₁^{(u}^{₁}⁾∥ . . . ∥A_{|u|}^{(u}^{_{|r|}}⁾∥B₁^{(u}^{_{|r+1|}}⁾∥ . . . B_{|u|-|r|}^{(u}^{_{|u|}}⁾εZ_{q}^{n×m′},
when the length of the hashed message is smaller than the number of members constituting the ring,
A=A₁^{(u}^{₁}⁾∥ . . . ∥A_{|r|}^{(u}^{_{|r|mod|u+1|}}⁾εZ_{q}^{n×m′},
when the length of the hashed message is same as the number of members constituting the ring,
A=A₁^{(u}^{₁}⁾∥ . . . ∥A_{|u|}^{(u}^{_{|u|}}⁾εZ_{q}^{n×m′}.

9. The method of claim 6, wherein said generating the signature for the message and the ring generates the signature for the message and the ring based on a result of applying the matrix A to an ExtBasis algorithm and a SampleD algorithm.

10. The method of claim 1 further comprising performing a verification by receiving the ring, the message, and the generated signature.

11. The method of claim 10, wherein said performing the verification includes:
calculating the length of the hashed message by receiving the ring, the message, and the generated signature; and
performing the verification by generating a matrix A for verification by using the length of the hashed message, the signature key, and the verifying key.
